(19) United States
(12) Patent Application Publication
(10) Pub. No.: US 2019/0062205 A1
(43) Pub. Date: Feb. 28, 2019

(54) ANTIMICROBIAL ARTICLES AND METHODS OF MAKING AND USING SAME

(71) Applicant: CORNING INCORPORATED, CORNING, NY (US)

(72) Inventors: Hongmei Hu, Painted Post, NY (US); Yuhui Jin, Painted Post, NY (US)

(21) Appl. No.: 16/109,266

(22) Filed: Aug. 22, 2018

Related U.S. Application Data
(60) Provisional application No. 62/551,471, filed on Aug. 29, 2017.

(51) Int. Cl. C03C 21/00; A01N 59/16

(52) U.S. Cl. CPC C03C 21/005; C03C 21/002; G06F 3/041; C03C 2204/02; A01N 59/16

(57) ABSTRACT

Described herein are various antimicrobial articles that have reduced discoloration after the formation of a silver-containing region in a substrate. The improved antimicrobial articles described herein generally include a substrate that comprises a compressive stress layer and a silver-containing region that each extend inward from a surface of the substrate to a specific depth, and has a uniform silver concentration profile across the surface of the substrate, such that the article exhibits little-to-no discoloration. Methods of making and using the articles are also described.

### CROSS-REFERENCE TO RELATED APPLICATIONS

This application claims the benefit of priority under 35 U.S.C. § 119 of U.S. Provisional Application Ser. No. 62/551,471 filed on Aug. 29, 2017, the content of which is relied upon and incorporated herein by reference in its entirety.

### TECHNICAL FIELD

The present disclosure relates generally to strengthened, antimicrobial articles for various applications including but not limited to touch screens for various electronic devices, e.g., mobile phones, laptop computers, book readers, hand-held video gaming systems, automated teller machines, elevator displays, and electronic signage. More particularly, the various embodiments described herein relate to articles having antimicrobial behavior and exhibiting reduced discoloration, as well as to methods of making and using the articles.

### BACKGROUND

Touch-activated or -interactive devices, such as screen surfaces (e.g., surfaces of electronic devices having user-interactive capabilities that are activated by touching specific portions of the surfaces), have become increasingly more prevalent in the electronic device industry. In general, these surfaces should exhibit high optical transmission, low haze, and high durability, among other features. As the extent to which the touch screen-based interactions between a user and a device increases, so too does the likelihood of the surface harboring microorganisms (e.g., bacteria, fungi, viruses, and the like) that can be transferred from user to user.

To minimize the presence of microbes on surfaces, “antimicrobial” properties have been imparted to a variety of articles. Such antimicrobial articles, regardless of whether they are used as screen surfaces of touch-activated devices or in other applications, have a propensity to discolor for various reasons and this can be particularly pronounced for transparent glass articles. For example, one reason for the discoloration includes the presence of a large amount of Ag on the surface of a glass article. In certain cases, this discoloration can render the glass article unsightly. Further, excessive discoloration ultimately can lead to the glass article becoming unsuitable for its intended purpose.

There accordingly remains a need for technologies that provide antimicrobial articles with reduced discoloration. It would be particularly advantageous if such technologies do not adversely affect other desirable properties of the surfaces (e.g., optical transmission, haze, strength, scratch resistance, and the like). It is to the provision of such technologies that the present disclosure is directed.

### BRIEF SUMMARY

According to a first aspect, an article is provided. The article comprises: a substrate comprising a compressive stress layer that extends inward from a surface of the substrate to a first depth therein and a silver-containing region that extends inward from the surface of the substrate to a second depth therein, wherein an Ag₂O concentration at a depth of 200 nanometers (nm) is greater than the Ag₂O concentration at a depth of 40 nanometers (nm).

In a second aspect according to the first aspect, wherein the second depth is less than the first depth.

In a third aspect according to the first or second aspect, wherein the article further comprises an additional layer disposed on the surface of the substrate.

In a fourth aspect according to the third aspect, wherein the additional layer comprises a reflection-resistant coating, a glare-resistant coating, a fingerprint-resistant coating, a smudge-resistant coating, a color-providing composition, an environmental barrier coating, or an electrically conductive coating.

In a fifth aspect according to any one of the first through fourth aspects, wherein a maximum compressive stress of the compressive stress layer is about 200 megapascals (MPa) to about 1.2 gigapascals (GPa) and a depth of the compressive stress layer is less than about 200 micrometers (μm).

In a sixth aspect according to any one of the first through fifth aspects, wherein the silver-containing region has a depth of less than or equal to about 150 micrometers (μm).

In a seventh aspect according to any one of the first through sixth aspects, wherein the article exhibits substantially no discoloration, wherein substantially no discoloration occurs as determined by at least one of: a change in optical transmittance of the article of less than or equal to about 3 percent relative to an optical transmittance after reduction by hydrogen (H₂), a change in haze of the article of less than or equal to about 5 percent relative to a haze after reduction by H₂, and a change in CIE 1976 color coordinates L*, a*, and b* of the article of less than or equal to about ±0.2, ±0.1, and ±0.1, respectively, after reduction by H₂.

In an eighth aspect according to any one of the first through seventh aspects, wherein after immersing the article having a size of 1.5 in×1.5 in in a 700 μL solution of 10 mM NaNO₃ at 60° C. for 2 hours, the article leaches up to about 100 parts per billion (ppb) of silver ions into the solution.

In a ninth aspect according to any one of the first through eighth aspects, wherein the article exhibits at least a 2 log reduction in a concentration of at least Staphylococcus aureus, Enterobacter aerogenes, and Pseudomonas aeruginosa bacteria under JIS Z 2801 (2000) testing conditions.

In a tenth aspect according to any one of the first through ninth aspects, wherein the substrate comprises at least one of a glass, glass ceramic and ceramic composition.

In an eleventh aspect according to any one of the first through tenth aspects, wherein the article comprises a portion of a touch-sensitive display screen or cover plate for an electronic device, a non-touch-sensitive component of an electronic device, a surface of a household appliance, a surface of medical equipment, a biological or medical packaging vessel, or a surface of a vehicle component.

According to a twelfth aspect, a consumer electronic product is provided. The consumer electronic product comprises: a housing having a front surface, a back surface and side surfaces; electrical components provided at least partially within the housing, the electrical components including at least a controller, a memory, and a display, the display being provided at or adjacent the front surface of the housing; and a cover substrate disposed over the display, wherein at least one of a portion of the housing or the cover substrate comprises the article according to any one of the first through eleventh aspects.

According to a thirteenth aspect, an article is provided. The article comprises: a substrate comprising a compressive stress layer that extends inward from a surface of the substrate to a first depth therein and a silver-containing region that extends inward from the surface of the substrate to a second depth therein, wherein across the surface of the substrate there is a maximum Ag₂O concentration [Ag₂Oₘₐₓ] and a minimum Ag₂O concentration [Ag₂Oₘᵢₙ], wherein [Ag₂Oₘₐₓ]−[Ag₂Oₘᵢₙ] is less than or equal to about 0.5 mol %.

In a fourteenth aspect according to the thirteenth aspect, wherein the second depth is less than the first depth.

In a fifteenth aspect according to the thirteenth or fourteenth aspect, wherein the article further comprises an additional layer disposed on the surface of the substrate.

In a sixteenth aspect according to the fifteenth aspect, wherein the additional layer comprises a reflection-resistant coating, a glare-resistant coating, a fingerprint-resistant coating, a smudge-resistant coating, a color-providing composition, an environmental barrier coating, or an electrically conductive coating.

In a seventeenth aspect according to any one of the thirteenth through sixteenth aspects, wherein a maximum compressive stress of the compressive stress layer is about 200 megapascals (MPa) to about 1.2 gigapascals (GPa) and a depth of the compressive stress layer is less than about 200 micrometers (μm).

In an eighteenth aspect according to any one of the thirteenth through seventeenth aspect, wherein the silver-containing region has a depth of less than or equal to about 150 micrometers (μm).

In a nineteenth aspect according to any one of the thirteenth through eighteenth aspects, wherein the article exhibits substantially no discoloration, wherein substantially no discoloration occurs as determined by at least one of: a change in optical transmittance of the article of less than or equal to about 3 percent relative to an optical transmittance after reduction by hydrogen (H₂), a change in haze of the article of less than or equal to about 5 percent relative to a haze after reduction by H₂, and a change in CIE 1976 color coordinates L*, a*, and b* of the article of less than or equal to about ±0.2, ±0.1, and ±0.1, respectively, after reduction by H₂.

In a twentieth aspect according to any one of the thirteenth through nineteenth aspects, wherein after immersing the article having a size of 1.5 in ×1.5 in in a 700 μL solution of 10 mM NaNO₃ at 60° C. for 2 hours, the article leaches up to about 100 parts per billion (ppb) of silver ions into the solution.

In a twenty-first aspect according to any one of the thirteenth through twentieth aspects, wherein the article exhibits at least a 2 log reduction in a concentration of at least Staphylococcus aureus, Enterobacter aerogenes, and Pseudomonas aeruginosa bacteria under JIS Z 2801 (2000) testing conditions.

In a twenty-second aspect according to any one of the thirteenth through twenty-first aspects, wherein the substrate comprises at least one of a glass, glass ceramic and ceramic composition.

In a twenty-third aspect according to any one of the thirteenth through twenty-second aspects, wherein the article comprises a portion of a touch-sensitive display screen or cover plate for an electronic device, a non-touch-sensitive component of an electronic device, a surface of a household appliance, a surface of medical equipment, a biological or medical packaging vessel, or a surface of a vehicle component.

In a twenty-fourth aspect according to any one of the thirteenth through twenty-third aspects, wherein [Ag₂Oₘₐₓ]−[Ag₂Oₘᵢₙ] is less than or equal to about 0.3 mol %.

According to a twenty-fifth aspect, a consumer electronic product is provided. The consumer electronic product comprises: a housing having a front surface, a back surface and side surfaces; electrical components provided at least partially within the housing, the electrical components including at least a controller, a memory, and a display, the display being provided at or adjacent the front surface of the housing; and a cover substrate disposed over the display, wherein at least one of a portion of the housing or the cover substrate comprises the article according to any one of the thirteenth through twenty-fourth aspects.

According to a twenty-sixth aspect, a method of making an article is provided. The method comprises contacting at least a surface of a substrate with a silver-containing medium comprising at least one kind of anion to form a silver-containing region in the substrate that extends inward from the surface of the substrate to a first depth, wherein an Ag₂O concentration at a depth of 200 nanometers (nm) is greater than the Ag₂O concentration at a depth of 40 nanometers (nm).

In a twenty-seventh aspect according to the twenty-sixth aspect, wherein the at least one kind of anion is selected from a group consisting of Cl⁻, SO₄²⁻, F⁻, I⁻, Br, CO₃²⁻, PO₄³⁻, and a mixture thereof.

In a twenty-eighth aspect according to the twenty-sixth or twenty-seventh aspect, wherein the method further comprises forming a compressive stress layer that extends inward from the surface of the substrate to a second depth.

In a twenty-ninth aspect according to the twenty-eighth aspect, wherein forming the silver-containing region and forming the compressive stress layer occur simultaneously.

In a thirtieth aspect according to any one of the twenty-sixth through twenty-ninth aspects, wherein the silver-containing medium is a molten salt bath comprising silver cations.

In a thirty-first aspect according to the thirtieth aspect, wherein the molten salt bath further comprises at least one of NaNO₃ and KNO₃.

In a thirty-second aspect according to the thirtieth or thirty-first aspect, wherein the silver cations are present in an amount in a range from about 0.1 wt % to about 10 wt %, based on the total weight of the molten salt bath.

In a thirty-third aspect according to any one of the thirtieth through thirty-second aspects, wherein the at least one kind of anion is present in an amount in a range from about 0.01 wt % to about 10 wt %, based on the total weight of the molten salt bath.

In a thirty-fourth aspect according to any one of the twenty-sixth through thirty-third aspects, wherein the silver-containing medium is heated to a temperature in a range from about 350° C. to about 450° C.

In a thirty-fifth aspect according to any one of the twenty-sixth through thirty-fourth aspects, wherein contacting the substrate with the silver-containing medium takes place for a duration in a range from about 10 minutes to about 10 hours.

In a thirty-sixth aspect according to any one of the twenty-sixth through thirty-fifth aspects, wherein the method further comprises forming an additional layer on at least a portion of the surface of the substrate, wherein the additional layer is selected from the group consisting of a reflection-resistant coating, a glare-resistant coating, a fingerprint-resistant coating, a smudge-resistant coating, a color-providing composition, an environmental barrier coating, and an electrically conductive coating.

In a thirty-seventh aspect according to any one of the twenty-sixth through thirty-sixth aspects, wherein the Ag₂O concentration at a depth of 40 nanometers (nm) inward from a surface of the article is up to about 2 mol %.

In a thirty-eighth aspect according to any one of the twenty-sixth through thirty-seventh aspects, wherein across the surface of the article there is a maximum Ag₂O concentration [Ag₂Oₘₐₓ] and a minimum Ag₂O concentration [Ag₂Oₘᵢₙ], wherein [Ag₂Oₘₐₓ]−[Ag₂Oₘᵢₙ] is less than or equal to about 0.5 mol %.

In a thirty-ninth aspect according to the thirty-eighth aspect, wherein [Ag₂Oₘₐₓ]−[Ag₂Oₘᵢₙ] is less than or equal to about 0.3 mol %.

In a fortieth aspect according to any one of the twenty-sixth through thirty-ninth aspects, wherein the article exhibits substantially no discoloration, wherein substantially no discoloration occurs as determined by at least one of: a change in optical transmittance of the article of less than or equal to about 3 percent relative to an optical transmittance after reduction by hydrogen (H₂), a change in haze of the article of less than or equal to about 5 percent relative to a haze after reduction by H₂, and a change in CIE 1976 color coordinates L*, a*, and b* of the article of less than or equal to about ±0.2, ±0.1, and ±0.1, respectively, after reduction by H₂.

Additional features and advantages will be set forth in the detailed description which follows, and in part will be readily apparent to those skilled in the art from that description or recognized by practicing the embodiments as described herein, including the detailed description which follows, the claims, as well as the appended drawings.

It is to be understood that both the foregoing general description and the following detailed description are merely exemplary, and are intended to provide an overview or framework to understanding the nature and character of the claims. The accompanying drawings are included to provide a further understanding, and are incorporated in and constitute a part of this specification. The drawings illustrate one or more embodiments, and together with the description serve to explain principles and operation of the various embodiments.

### BRIEF DESCRIPTION OF THE DRAWINGS

FIG. 1 is an exemplary schematic of a method of making a strengthened, antimicrobial article according to some embodiments of the present disclosure;

FIG. 2 is an exemplary schematic of a strengthened, antimicrobial article according to some embodiments of the present disclosure;

FIG. 3 is an exemplary schematic illustrating the generation of discoloration caused by ion exchange;

FIG. 4 is an exemplary schematic illustrating an ion exchange process using a molten salt bath containing chloride ions according to some embodiments of the present disclosure;

FIG. 5 is a Secondary Ion Mass Spectrometry (SIMS) plot of Ag₂O concentration in mol % as a function of depth in glass articles subjected to various ion exchange conditions according to some embodiments of the present disclosure;

FIG. 6A is a plan view of an exemplary electronic device incorporating any of the articles disclosed herein; and

FIG. 6B is a perspective view of the exemplary electronic device of FIG. 6A.

### DETAILED DESCRIPTION

In the following detailed description, for purposes of explanation and not limitation, example embodiments disclosing specific details are set forth to provide a thorough understanding of various principles of the present disclosure. However, it will be apparent to one having ordinary skill in the art, having had the benefit of the present disclosure, that the present disclosure may be practiced in other embodiments that depart from the specific details disclosed herein. Moreover, descriptions of well-known devices, methods and materials may be omitted so as not to obscure the description of various principles of the present disclosure. Finally, wherever applicable, like reference numerals refer to like elements.

Ranges can be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

Directional terms as used herein—for example up, down, right, left, front, back, top, bottom—are made only with reference to the figures as drawn and are not intended to imply absolute orientation.

Unless otherwise expressly stated, it is in no way intended that any method set forth herein be construed as requiring that its steps be performed in a specific order. Accordingly, where a method claim does not actually recite an order to be followed by its steps, or it is not otherwise specifically stated in the claims or descriptions that the steps are to be limited to a specific order, it is in no way intended that an order be inferred, in any respect. This holds for any possible non-express basis for interpretation, including: matters of logic with respect to arrangement of steps or operational flow; plain meaning derived from grammatical organization or punctuation; and the number or type of embodiments described in the specification.

As used herein, the singular forms “a,” “an” and “the” include plural referents unless the context clearly dictates otherwise. Thus, for example, reference to a “component” includes aspects having two or more such components, unless the context clearly indicates otherwise.

Described herein are various strengthened articles that comprise a substrate having a compressive stress layer that extends inward from a surface of the substrate to a first depth and a silver-containing region that extends inward from the surface of the substrate to a second depth, along with methods for their manufacture and use. By incorporating silver in the surface, antimicrobial properties are imparted therein. The term “antimicrobial” refers herein to the ability to kill or inhibit the growth of more than one species or more than one type of microbe (e.g., bacteria, viruses, fungi, and the like). Throughout this specification, the term “compressive stress layer” shall be used to refer to the layer or region of compressive stress, and the term “silver-containing region” shall be used to refer to the layer or region containing silver species. This usage is for convenience only, and is not intended to provide a distinction between the terms “region” or “layer” in any way.

In general, the articles described herein display reduced discoloration or coloration. In some embodiments, the articles exhibit an Ag concentration at a depth of 200 nm greater than the Ag concentration at a depth of 40 nm. In some embodiments, the silver concentration is converted to and expressed as Ag₂O concentration, although Ag₂O may not even exist in the articles. Therefore, according to some exemplary embodiments, the articles exhibit an Ag₂O concentration at a depth of 200 nm greater than the Ag₂O concentration at a depth of 40 nm. The use of “Ag₂O concentration” is for convenience only, and by no means implies the presence of Ag₂O within the articles.

The methods described herein generally involve the use of at least one kind of anion in a silver-containing molten salt bath in an ion exchange process. The at least one kind of anion is adapted to react with silver cations to form a silver salt having a melting point higher than the ion exchange temperature.

Substrate

The choice of substrate is not limited to a particular composition. For example, the composition chosen can be any of a wide range of glass, glass ceramic, or ceramic compositions. In the case of a glass substrate, the substrate can comprise at least one of a silicate, borosilicate, aluminosilicate, boroaluminosilicate, soda-lime, and other alkali-containing and alkali-free glass composition. In some embodiments, the article comprises a substrate having an ion-exchangeable glass composition containing one or more alkali metals.

With regard to glass ceramic compositions, the material chosen for the substrate of the article can be any of a wide range of materials having both a glassy (amorphous) phase and a ceramic (crystallized) phase. Illustrative glass ceramics include those materials where the glass phase is formed from a silicate, borosilicate, aluminosilicate, or boroaluminosilicate, and the ceramic phase is formed from β-spodumene, β-quartz, nepheline, kalsilite, petalite, or carnegieite. “Glass ceramics” include materials produced through controlled crystallization of glass. In various embodiments, glass ceramics have about 1% to about 99% crystallinity. Non-limiting examples of glass ceramic systems that may be used include Li₂O×Al₂O₃×nSiO₂ (i.e. LAS system), MgO×Al₂O₃×nSiO₂ (i.e. MAS system), and ZnO×Al₂O₃×nSiO₂ (i.e. ZAS system).

With respect to ceramics, the material chosen for the substrate of the article can be any of a wide range of inorganic crystalline oxides, nitrides, carbides, oxynitrides, carbonitrides, and/or the like. Illustrative ceramics include those materials having an alumina, aluminum titanate, mullite, cordierite, zircon, spinel, persovskite, zirconia, ceria, silicon carbide, silicon nitride, silicon aluminum oxynitride or zeolite phase.

The substrate can adopt a variety of physical forms. That is, from a cross-sectional perspective, the substrate can be flat or planar, or it can be curved and/or sharply-bent. Similarly, it can be a single unitary object, or a multi-layered structure or a laminate.

There is no particular limitation on the thickness of the substrate contemplated herein. In many exemplary applications, the thickness may be less than or equal to about 15 millimeters (mm). If the article is to be used in applications where it may be desirable to optimize thickness for weight, cost, and strength characteristics (e.g., in electronic devices, or the like), then even thinner substrates (e.g., less than or equal to about 5 mm) can be used. By way of example, if the article is intended to function as a cover for a touch screen display, then the substrate can exhibit a thickness of about 0.02 mm to about 2.0 mm.

Compressive Stress Layer

The article of one or more embodiments includes a compressive stress layer or region that extends inward from a surface of the substrate to a specific depth therein. This compressive stress layer can be formed from a strengthening process (e.g., by thermal tempering, chemical ion-exchange, or like processes), as will be described in greater detail herein.

With thermal tempering, the substrate generally is heated above its annealing point, followed by a rapid cooling step to quench an outer or exterior region of the substrate in a compressed state, while an interior region of the substrate cools at a slower rate and is placed under tension. The heating temperature, heating time, and cooling rate are generally the primary parameters that can be tailored to achieve a desired compressive stress (CS) and depth of compression (DOC) in the compressive stress layer (the exterior region of the substrate in a compressed state).

With chemical ion exchange, the substrate is contacted with an ion exchange bath (e.g., by dipping, immersing, spraying, or the like), during which smaller cations in the outer or exterior region of the substrate are replaced by, or exchanged with, larger cations of the same valence (usually ¹⁺) from the ion exchange bath to place the outer or exterior region under compression, while an interior region of the substrate (in which no ion exchange occurs) is put under tension. Conditions such as contacting time, ion exchange temperature, and salt concentration in the ion exchange bath can be tailored to achieve a desired DOC and CS in the compressive stress layer (the exterior region in which the ion exchange occurs).

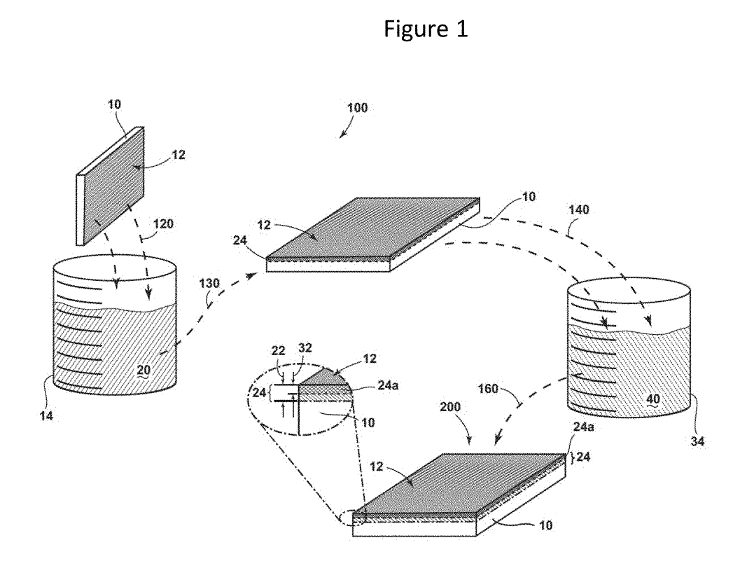

Referring to FIG. 1, a method of making an antimicrobial glass article 100 is provided. In the method 100, a glass article 10 is employed having a first surface 12 and a plurality of ion-exchangeable metal ions. As shown in FIG. 1, glass article 10 possesses other exterior surfaces in addition to first surface 12. In exemplary embodiments, glass article 10 can comprise a silicate composition having ion-exchangeable metal ions. The metal ions are exchangeable in the sense that exposure of the glass article 10 and first surface 12 to a bath containing other metal ions can result in the exchange of some of the metal ions in the glass article 10 with metal ions from the bath. In one or more embodiments, a compressive stress is created by this ion exchange process in which a plurality of first metal ions in glass article 10, and specifically the first surface 12, are exchanged with a plurality of second metal ions (having an ionic radius larger than the plurality of first metal ions) so that a region of the glass article 10 comprises the plurality of the second metal ions. The presence of the larger second metal ions in this region creates the compressive stress in the region. The first metal ions may be alkali metal ions such as lithium, sodium, potassium, and rubidium. The second metal ions may be alkali metal ions such as sodium, potassium, rubidium, and cesium, with the proviso that the second alkali metal ion has an ionic radius greater than the ionic radius of the first alkali metal ion.

Referring again to FIG. 1, the method of making an antimicrobial glass article 100 employs a strengthening bath 20 contained within a vessel 14. The strengthening bath 20 contains a plurality of ion-exchanging metal ions. In some embodiments, for example, bath 20 may contain a plurality of potassium ions that are larger in size than ion-exchangeable ions, such as sodium, contained in the glass article 10. These ion-exchanging ions contained in the bath 20 will preferentially exchange with ion-exchangeable ions in the glass article 10 when the article 10 is submersed in the bath 20. The strengthening bath 20 may contain a molten salt bath comprising at least KNO₃, sufficiently heated to a temperature to ensure that the salt remains in a molten state during processing of the glass article 10. The strengthening bath 20 may also include the combination of KNO₃ and one or both of NaNO₃ and LiNO₃.

Still referring to FIG. 1, the method of making an antimicrobial glass article 100 depicted in FIG. 1 includes a step 120 of submersing the glass article 10 into the strengthening bath 20. Upon submersion into the bath 20, a portion of the plurality of the ion-exchangeable ions (e.g., Na⁺ ions) in the glass article 10 are exchanged with a portion of the plurality of the ion-exchanging ions (e.g., K⁺ ions) contained in the strengthening bath 20. According to some embodiments, the submersion step 120 is conducted for a predetermined time based on the composition of the bath 20, temperature of the bath 20, composition of the glass article 10 and/or the desired concentration of the ion-exchanging ions in the glass article 10. In some embodiments, the ion exchange temperature can be in a range from about 350° C. to about 450° C., from about 380° C. to about 440° C., or from about 390° C. to about 430° C. In some embodiments, the submersion step is conducted for about 10 minutes to about 10 hours, from about 0.5 hour to about 5 hours, from about 1 hour to about 3 hour, and all ranges and subranges therebetween.

After the submersion step 120 is completed, a washing step 130 is conducted to remove the material from the bath 20 remaining on the surfaces of glass article 10, including the first surface 12. Deionized water, for example, can be used in the washing step 130 to remove the material from the bath 20 on the surface of the glass article 10. Other media may also be employed for washing the surfaces of the glass article 10 provided that the media are selected to avoid any reactions with the material from the bath 20 and/or the glass composition of the glass article 10.

As the ion-exchanging ions from the bath 20 are distributed into the glass article 10 at the expense of the ion-exchangeable ions originally in the glass article 10, a compressive stress layer 24 develops in the glass article 10. The compressive stress layer 24 extends from the first surface 12 to a diffusion depth 22 in the glass article 10. In general, an appreciable concentration of the ion-exchanging ions from the strengthening bath 20 (e.g., K⁺ ions) exists in the compressive stress layer 24 after the submersion and cleaning steps 120 and 130, respectively. These ion-exchanging ions are generally larger than the ion-exchangeable ions (e.g., Na⁺ ions), thereby increasing the compressive stress level in the layer 24 within the glass article 10.

The amount of CS and the DOC can be varied based on the particular use of the article, with the proviso that the CS level and DOC should be limited such that a tensile stress created within the substrate as a result of the compressive stress layer does not become so excessive as to render the article frangible. In one or more embodiments, the CS level at the surface of the substrate is at least about 200 MPa, at least about 300 MPa, at least about 400 MPa, at least about 500 MPa, at least about 600 MPa, or at least about 700 MPa, and no more than about 1.2 GPa, no more than about 1.1 GPa, no more than about 1 GPa, no more than about 900 MPa, or no more than about 800 MPa, and any ranges and subranges therebetween. In various applications, the maximum compressive stress is in a range from about 200 MPa to about 1.2 GPa.

While the ultimate limit on the CS level and DOC is the avoidance of rendering the article frangible, the DOC of the compressive stress layer generally may be less than about one-third of the thickness of the substrate. In most applications, however, the DOC may be less than or equal to about 200 μm, greater than or equal to about 25 μm to less than or equal to about 200 μm, and all ranges and subranges therebetween. In some instances, DOC can be in the range from about 100 μm to about 200 μm.

Silver-Containing Region

The article of one or more embodiments includes a silver-containing layer or region that extends inward from a surface of the article to a second depth therein. The silver-containing region comprises cationic monovalent silver (Ag⁺) in an amount effective to impart antimicrobial behavior to the article. Thus, the Ag⁺ ions interact with microbes at the surface of the article to kill them or otherwise inhibit their growth. In general, the silver-containing region, like the compressive stress layer, extends inward from the surface of the article to a depth of the silver-containing region (DOR). Thus the silver-containing region at least partially overlaps with the compressive stress layer. In one or more embodiments, the DOR may be generally limited to avoid visible discoloration or coloration in the article and to maximize the antimicrobial efficacy of the cationic silver within the article. For example, the DOR may be about 20 μm or less, about 18 μm or less, about 16 μm or less, about 14 μm or less, about 12 μm or less, about 10 μm or less, about 8 μm or less, or about 5 μm or less, and about 0.1 μm or more, about 1 μm or more, about 5 μm or more, about 6 μm or more, about 7 μm or more, about 8 μm or more, about 9 μm or more, about 10 μm or more, about 12 μm or more, about 14 μm or more, or about 16 μm or more, and all ranges and subranges therebetween.

In some embodiments, DOC is greater than the DOR. In one or more alternative embodiments, the DOC and the DOR are about the same. In some specific alternative embodiments, the DOR may be greater than the DOC. In such embodiments, the DOR may be up to about 150 μm (e.g., in a range from about 20 μm to about 150 μm).

The silver-containing region can be formed in a variety of ways, of which chemical diffusion (which optionally can be accompanied by the exchange of another cation out from the substrate) of cationic silver from a silver-containing medium (e.g., paste, dispersion, ion exchange bath of molten salts, or the like) is the most common. In general, a substrate is contacted with a silver-containing medium (e.g., by dipping, immersing, spraying, or the like), and cationic silver diffuses from the silver-containing medium into an outer or exterior region of the substrate. In most situations, however, the cationic silver replaces, or exchanges with, another cations of the same valence (e.g., K⁺) from the silver-containing medium. Conditions such as contacting time, silver-containing medium temperature, and silver concentration in the silver-containing medium can be tailored to achieve a desired DOR and silver concentration profile in the silver-containing region (the exterior region in which the cationic silver diffuses or ion exchanges).

One aspect of the subject application provides methods of forming a silver-containing region in a substrate which include the step of contacting the substrate with a silver-containing medium. In some embodiments, the silver-containing medium is a molten salt bath comprising silver cations.

Methods of forming a silver-containing region in a substrate may further comprise forming a compressive stress layer that extends inward from the surface of the substrate. In one or more embodiments, forming the compressive stress layer occurs before forming the silver-containing region. By way of example, one exemplary implementation of a method where the compressive stress layer is formed before the silver-containing region entails immersing the substrate into a molten KNO₃ bath to impart the compressive stress via ion exchange followed by immersing the strengthened substrate into an AgNO₃-containing molten salt bath to ion exchange Ag⁺ into the glass.

Referring again to FIG. 1, the method of making an antimicrobial glass article 100 additionally employs a step 140 for submersing the ion-exchanged glass article 10 into an antimicrobial bath 40, which is contained in a vessel 34 that comprises a plurality of metal ions that can provide an antimicrobial effect. In some embodiments, the antimicrobial bath 40 includes a plurality of silver ions, each of which can provide an antimicrobial effect; a plurality of ion-exchangeable metal ions consistent with those present in the as-produced glass article 10; and a plurality of ion-exchanging ions consistent with those present in the strengthening bath 20. According to exemplary embodiments, the bath 40 possesses a plurality of silver ions derived from molten AgNO₃ at a bath concentration of about 0.01% to 100% by weight. In additional embodiments, the antimicrobial bath 40 possesses about 0.5% to up to about 50% by weight molten AgNO₃ with a balance of molten KNO₃ and/or NaNO₃. For example, the antimicrobial bath 40 can comprise a molten mixture of 50% AgNO₃ and 50% KNO₃+NaNO₃ by weight.

After the submersion step 160 is completed, a washing step 170 can be conducted to remove the material from the bath 40 remaining on the surfaces of glass article 10, including first surface 12. Deionized water, for example, can be used in the washing step 170 to remove the material from the bath 40 on the surfaces of the glass article 10. Other media may also be employed for washing the surfaces of the glass article 10 provided that the media is selected to avoid any reactions with the material from the bath 40 and/or the glass composition of the glass article 10.

In one or more alternative embodiments, the compressive stress layer and the silver-containing region are formed simultaneously. By way of another example, one exemplary implementation of a method where the compressive stress layer and the antimicrobial silver-containing region are formed simultaneously entails immersing a glass substrate into a molten salt bath comprising both KNO₃ and AgNO₃ to ion exchange K⁺ and Ag⁺ into the glass substrate together. In some embodiments, the molten salt bath includes at least one kind of anion that can react with Ag⁺ to form a silver salt and precipitate during cooling.

In yet additional embodiments, forming the compressive stress occurs after forming the silver-containing region. By way of still another example, one exemplary implementation of a method where the compressive stress layer is formed after the silver-containing region entails immersing a glass substrate into a AgNO₃-containing molten salt bath to ion exchange Ag⁺ into the glass substrate followed by immersing the Ag-containing glass into a molten KNO₃ bath to impart the compressive stress via ion exchange.

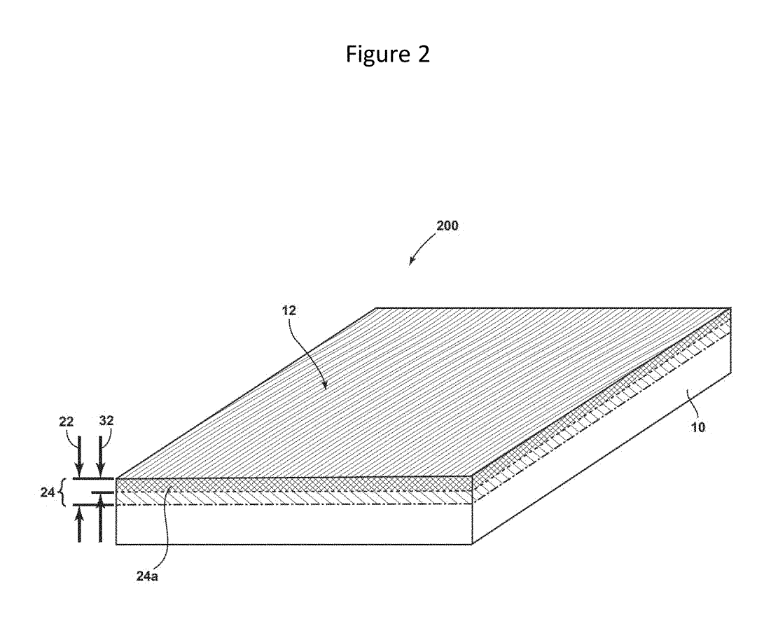

Referring to FIG. 2, a strengthened, antimicrobial glass article 200 is provided according to exemplary embodiments. The antimicrobial glass article 200 includes: a glass article 10 comprising a primary surface 12; a compressive stress layer 24 extending from the primary surface 12 of the glass article to a first depth 22 in the glass article; and an silver-containing region 24a comprising a plurality of silver ions extending from the primary surface 12 to a second depth 32 in the glass article. Such articles 200 depicted in FIG. 2 can be fabricated according to the method 100 outlined in FIG. 1.

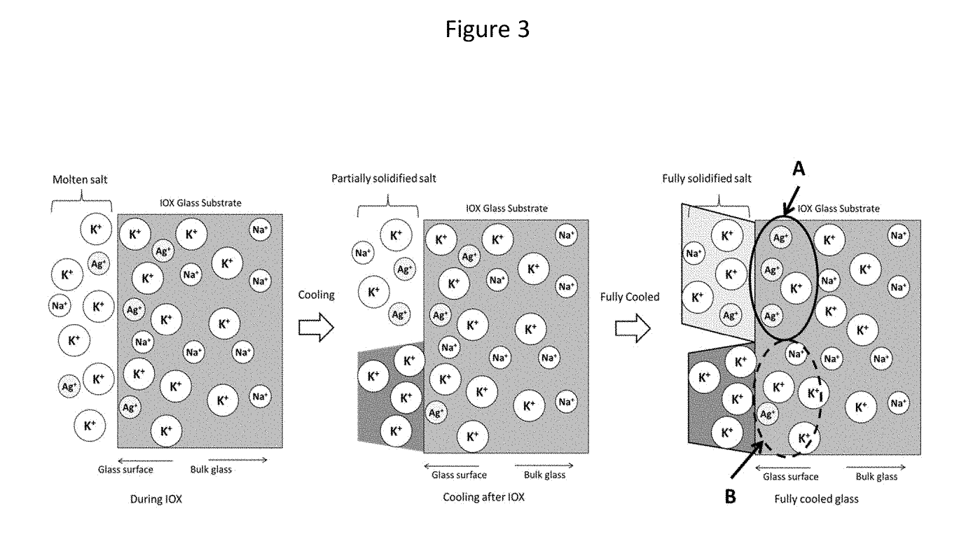

According to some embodiments, as shown in FIG. 3, when the strengthened glass article 10 is pulled out from the antimicrobial bath 40, some molten salts (e.g., KNO₃, NaNO₃ and AgNO₃) stick onto the surface. As the salt is cooled down, some of the major components (such as KNO₃) start to solidify or crystallize and occupy part of the substrate surface. Because the melting point of AgNO₃ is very low (lower than KNO₃ and NaNO₃), AgNO₃ stays in liquid phase and gets concentrated, and continues to ion exchange at the surface that is not blocked by the solidified salt even at a lower temperature. This differential ion exchange process continues until all the molten salt is completely frozen, thus resulting in a non-uniform silver concentration at the surface (e.g., Region A has more silver ions than Region B). The region with more silver ions (B) is more yellowish than the region with less silver ions (A) and the silver-rich region (B) appears as a stain defect on the substrate surface.

To address the above problem, in some embodiments, the silver-containing medium (for example the molten salt bath) contains at least one kind of anion other than, or in addition to, NO₃⁻. In these embodiments, the at least one kind of anion is adapted to react with silver cations to form a silver salt with a melting point higher than the ion exchange temperature. In some embodiments, the at least one kind of anion other than, or in addition to, NO₃⁻ can be Cl⁻, SO₄²⁻, F⁻, I⁻, Br, CO₃²⁻, PO₄³⁻, or mixtures thereof.

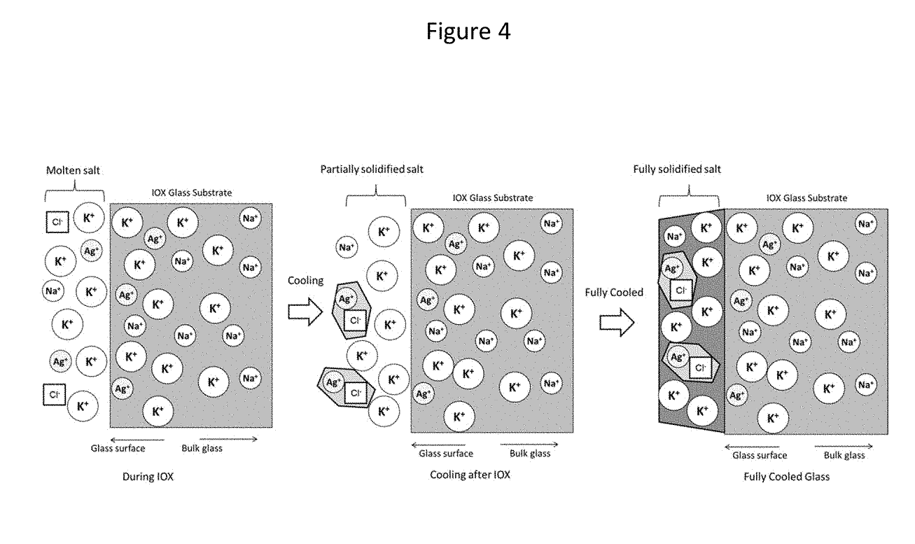

As can be seen in FIG. 3, it has been found that when NO₃⁻ is used without additional anions in the silver-containing medium (for example the molten salt bath), discoloration often occurs in the article. Use of at least one kind of anion other than, or in addition to, NO₃⁻ such as Cl⁻, SO₄²⁻, F⁻, I⁻, Br, CO₃²⁻, PO₄³⁻, or mixtures thereof may reduce or prevent discoloration. For example, when chloride ions are added to the molten salt bath, during ion exchange, silver and chloride ions are combined to form AgCl which is soluble at the ion exchange temperature. Because the melting point of AgCl is much higher than KNO₃ and NaNO₃, during cooling post ion exchange, AgCl solidifies first, followed by the solidification of KNO₃ and NaNO₃ at lower temperatures, as illustrated in FIG. 4. As a result, when all the salts on glass surface are cooled down, silver ions are not concentrated at some surface locations nor introducing surface stain defects, as opposed to the scenario depicted in FIG. 3, where silver ions can remain soluble and ion-exchangeable during cooling.

The silver cations can be present in the molten salt bath in an amount of at least about 0.01 wt %, at least about 0.1 wt %, at least about 0.2 wt %, at least about 0.25 wt %, or at least about 0.5 wt %, and not more than about 50 wt %, not more than about 10 wt %, not more than about 5 wt %, not more than about 2 wt %, or not more than about 1 wt %, and all ranges and subranges therebetween. The at least one kind of anion (other than or in addition to NO₃) should be present in the molten salt bath in an amount sufficient to react with all silver cations remaining at the surface of the substrate during the cooling process after being pulled out from the ion exchange bath. Preferably the at least one kind of anion is at least about 0.01 wt %, at least about 0.1 wt %, at least about 0.2 wt %, at least about 0.25 wt %, or at least about 0.5 wt %, and not more than about 50 wt %, not more than about 10 wt %, not more than about 5 wt %, not more than about 2 wt %, or not more than about 1 wt %, and all ranges and subranges therebetween. In some embodiments, the molten salt bath can further include at least one of NaNO₃ and KNO₃. In some embodiments, the ion exchange temperature can be in the range from about 350° C. to about 450° C., from about 380° C. to about 440° C., or from about 390° C. to about 430° C. In some embodiments, the contact time can last from about 10 minutes to about 5 hours to ensure the formation of the silver-containing region with desired DOR and silver concentration profile, from about 0.5 hour to about 2 hours, or from about 0.5 hour to about 1 hour.

In certain implementations, the outmost surface (e.g., about 5 nm within the surface) of the silver-containing region can have an Ag₂O concentration of less than or equal to about 2 mol % and, in some cases, up to about 1 mol %, up to about 0.5 mol %, or up to about 0.1%. According to some embodiments, the article has a uniform silver profile across the surface of the substrate. Across the surface, there is a maximum Ag₂O concentration [Ag₂Oₘₐₓ] and a minimum Ag₂O concentration [Ag₂Oₘᵢₙ], and [Ag₂Oₘₐₓ]−[Ag₂Oₘᵢₙ] is less than or equal to about 0.5 mol %. In some specific examples, [Ag₂Oₘₐₓ]−[Ag₂Oₘᵢₙ] is less than or equal to about 0.3 mol %. Both [Ag₂Oₘₐₓ] and [Ag₂Oₘᵢₙ] can be determined by measuring Ag₂O at the outmost surface.

In some embodiments, the silver-containing region can have an Ag₂O concentration at a depth of 40 nm from the surface of less than or equal to about 2 mol % and, in some cases, up to about 1.5 mol %, up to about 0.1 mol %, up to about 0.5%, up to about 0.3%, and all ranges and subranges therebetween. In further embodiments, the silver-containing region can have an Ag₂O concentration at a depth of 200 nm from the surface of less than or equal to about 1.5 mol %, less than or equal to about 1 mol %, less than or equal to about 0.5 mol %, less than or equal to about 0.2 mol %, and all ranges and subranges therebetween. According to some exemplary embodiments, the article exhibits an Ag₂O concentration at a depth of 200 nm greater than the Ag₂O concentration at a depth of 40 nm. In further embodiments, the Ag₂O concentration at a depth of 200 nm is at least 0.1 mol %, at least 0.2 mol %, at least 0.5 mol %, or at least 1 mol % greater than the Ag₂O concentration at a depth of 40 nm.

According to some embodiments, the article has a region where the surface Ag₂O concentration is monotonically increasing. The thickness of this region can be less than or equal to about 500 nm, less than or equal to about 400 nm, less than or equal to about 300 nm, less than or equal to about 200 nm, or less than or equal to about 100 nm.

In some embodiments, the method includes forming the silver-containing region by exchanging a plurality of silver cations from the silver-containing medium for a plurality of specific or first cations from the substrate. In some embodiments, the first cations are present in the substrate before or after the compressive stress layer is formed. For example, in some embodiments, the substrate includes such first cations before forming the compressive stress layer and such first cations may include sodium, lithium or a combination thereof. In some embodiments, the first cations are introduced into the substrate when forming the compressive stress layer, and may be preset at or near the surface of the substrate where they may be available for exchange with other cations (e.g., silver cations). In such embodiments, the first cations may include sodium, lithium or a combination thereof, which are introduced into the substrate by immersing the substrate in a molten salt bath. The strengthening bath may also include other salts used to form the compressive stress layer.

Provision of the substrate can involve selection of an object as-manufactured, or it can entail subjecting the as-manufactured object to a treatment in preparation for any of the subsequent steps. Examples of such treatments include physical or chemical cleaning, physical or chemical etching, physical or chemical polishing, annealing, shaping, and/or the like.

Furthermore, it should be noted that between any of the above-described steps, the substrate can undergo a treatment in preparation for any of the subsequent steps. As described above, examples of such treatments include physical or chemical cleaning, physical or chemical etching, physical or chemical polishing, annealing, shaping, and/or the like.

Reduced Discoloration

In general, the optical transmittance of the article will depend on the type of materials chosen. For example, if a glass substrate is used without any pigments added thereto and/or any optional additional layers are sufficiently thin, the article can have a transparency over the entire visible spectrum of at least about 85%. In certain cases where the article is used in the construction of a touch screen for an electronic device, for example, the transparency of the article can be at least about 90% over the visible spectrum. In situations where the substrate comprises a pigment (or is not colorless by virtue of its material constituents) and/or any optional additional layers are sufficiently thick, the transparency can diminish, even to the point of being opaque across the visible spectrum. Thus, there is no particular limitation on the optical transmittance of the article itself.

Like transmittance, the haze of the article can be tailored to the particular application. As used herein, the terms “haze” and “transmission haze” refer to the percentage of transmitted light scattered outside an angular cone of ±4.0° in accordance with ASTM procedure D1003, the contents of which are incorporated herein by reference in their entirety as if fully set forth below. For an optically smooth surface, transmission haze is generally close to zero. In those situations when the article is used in the construction of a touch screen for an electronic device, the haze of the article can be less than or equal to about 5%, or more specifically, less than or equal to about 1%.

One or more of the embodiments of the articles described herein offer reduced discoloration relative to existing antimicrobial articles. Using traditional silver ion exchange methods, the discoloration caused by the formation of the silver-containing region may be readily visible, whereas in many embodiments, the discoloration can only be detected upon reduction by hydrogen (H₂) to reduce residual Ag⁺ on the surface to Ag⁰, which can be easily visualized as surface stain or defect. In contrast, articles made according to the disclosed methods can exhibit substantially no discoloration even subject to H₂ reduction. While discoloration or no discoloration can appear to be a qualitative and potentially subjective characterization, there are a number of quantifiable indications of “substantially no discoloration”, examples of which will now be described.

One quantifiable indication of this “substantially no discoloration” can be seen in the change in the optical transmittance that is observed over time. This change can be measured after formation of the silver-containing region but before the article is reduced by H₂ and after the article is reduced by H₂. In general, the optical transmittance of the substrates described herein can be substantially similar both before and after reduction by H₂. In certain implementations, the change in the transmittance of the substrates described herein after reduction by H₂ can be about ±3%. In other implementations, the change in the transmittance of the substrates described herein after reduction by H₂ can be about ±0.5%.

Another quantifiable indication of “substantially no discoloration” is the change in absorbance at about 430 nm, which corresponds to the plasmon resonance associated with the formation of metallic silver nanoparticles (from cationic silver species) in the substrate, over time. This change can be measured before and after reduction by H₂. In general, the absorbance at about 430 nm of the substrates described herein can be substantially similar both before and after reduction by H₂. In certain implementations, the change in the absorbance at about 430 nm of the substrates described herein after reduction by H₂ can be about ±25%. In other implementations, the change in the absorbance at about 430 nm of the substrates described herein after reduction by H₂ can be about ±10%.

Yet another quantifiable indication of the improved resistance to discoloration is the change in haze that is observed over time. This change can be measured before and after reduction by H₂ in the article. In general, the overall haze of the articles described herein after reduction by H₂ can be substantially similar to the haze of the articles before reduction by H₂. In certain implementations, the change in the haze of the articles described herein after reduction by H₂ can be about ±5%. In other implementations, the change in the haze of the articles described herein after reduction by H₂ can be about ±2%.

Still another quantifiable indication of the improved resistance to discoloration is the change in CIE 1976 color space coordinates that is observed over time. This change can be measured before and after reduction by H₂ in the article. In general, the individual coordinates (i.e., L*, a*, and b*) of the articles described herein after the reduction by H₂ can be substantially similar to the individual coordinates of the articles before reduction by H₂. In certain implementations, the change in the L*, a*, and b* coordinates of the articles described herein after reduction by H₂ can be about ±0.2, ±0.1, and ±0.1, respectively. In other implementations, the change in the L*, a*, and b* coordinates of the articles described herein after reduction by H₂ can be about ±0.1, ±0.05, and ±0.05, respectively.

Antimicrobial Activity and Efficacy

The antimicrobial activity and efficacy of the articles described herein can be quite high. The antimicrobial activity and efficacy can be measured in accordance with Japanese Industrial Standard JIS Z 2801 (2000), entitled “Antimicrobial Products—Test for Antimicrobial Activity and Efficacy,” the contents of which are incorporated herein by reference in their entirety as if fully set forth below. Under the “wet” conditions of this test (i.e., about 37° C. and greater than 90% humidity for about 24 hours), the antimicrobial articles described herein can exhibit at least a 2 log reduction in the concentration (or a kill rate of 99%) of at least Staphylococcus aureus, Enterobacter aerogenes, and Pseudomonas aeruginosa bacteria. In certain implementations, the antimicrobial articles described herein can exhibit at least a 5 log reduction in the concentration of any bacteria to which it is exposed under these testing conditions.

In many embodiments, the antimicrobial activity and efficacy of the articles are linearly correlated with Ag leaching, and therefore leaching tests can be used as surrogate tests for the JIS Z 2801 test. For example, 70 ppb of Ag in the leachate can indicate a >2 log kill efficacy. The leaching tests can be performed at a high temperature, high humidity and/or high pressure, and with additives that can speed up or increase Ag leaching. Such leaching tests can accurately predict the antimicrobial efficacy, provide high throughput, and be deployed as a QC tool for manufacturing.

The Articles

Once the article is formed, it can be used in a variety of applications where the article will come into contact with undesirable microbes. These applications encompass touch-sensitive display screens or cover plates for various electronic devices (e.g., cellular phones, personal data assistants, computers, tablets, global positioning system navigation devices, and the like), non-touch-sensitive components of electronic devices, surfaces of household appliances (e.g., refrigerators, microwave ovens, stovetops, oven, dishwashers, washers, dryers, and the like), medical equipment, biological or medical packaging vessels, and vehicle components, just to name a few devices.

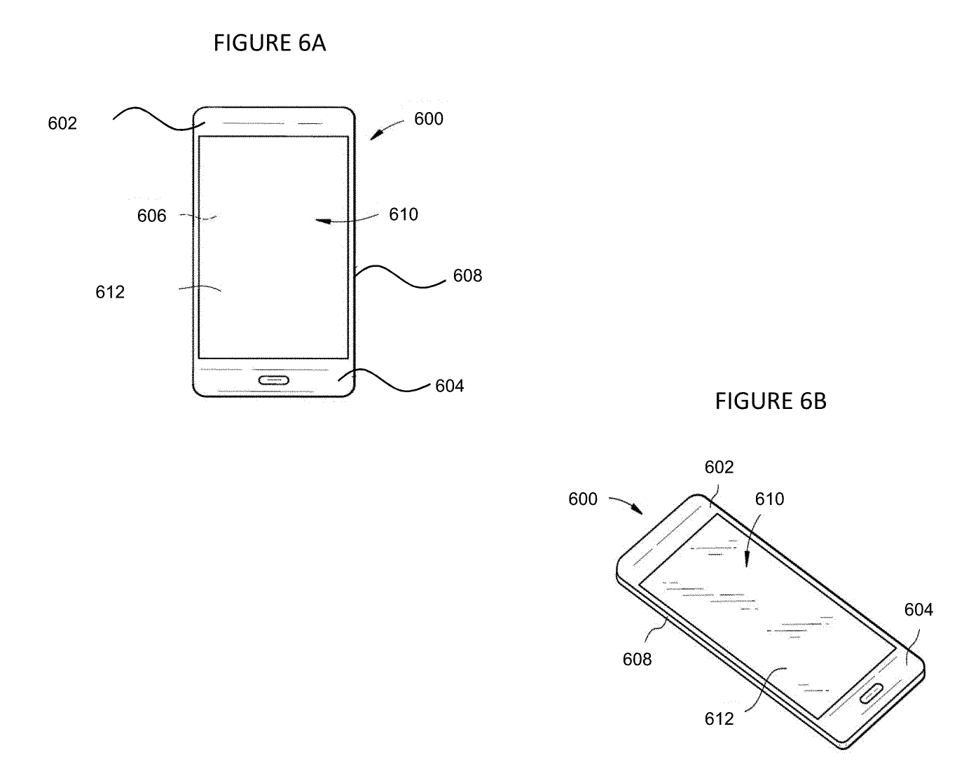

An exemplary article incorporating any of strengthened, antimicrobial articles disclosed herein is shown in FIGS. 6A and 6B. Specifically, FIGS. 6A and 6B show a consumer electronic device 600 including a housing 602 having front 604, back 606, and side surfaces 608; electrical components (not shown) that are at least partially inside or entirely within the housing and including at least a controller, a memory, and a display 610 at or adjacent to the front surface of the housing; and a cover substrate 612 at or over the front surface of the housing such that it is over the display. In some embodiments, the cover substrate 612 may include any of the strengthened, antimicrobial articles disclosed herein.

Given the breadth of potential uses for the improved articles described herein, it should be understood that the specific features or properties of a particular article will depend on the ultimate application therefor or use thereof. The following description, however, will provide some general considerations.

As stated above, the thickness of the silver-containing region can be limited so as to avoid visible discoloration or coloration in the article and to maximize the antimicrobial efficacy of the cationic silver within the substrate. The thickness of the silver-containing region may be less than the DOC of the compressive stress layer. In some embodiments, as with the DOC of the compressive stress layer, the thickness of the silver-containing region in one or more embodiments may be less than about one-third of the thickness of the substrate. In some alternative embodiments, the thickness of the silver-containing region may be up to about 100 μm, up to about 150 μm, up to about 300 μm, or up to the entire thickness of the substrate. The exact thickness, however, will vary depending on how the silver-containing region is formed.

For example, if the silver-containing region is formed before or after the compressive stress layer, and both are formed via chemical ion exchange, then the thickness of the silver-containing region generally may be less than or equal to about 20 μm. In many such cases, the thickness of the silver-containing region may be less than or equal to about 10 μm, less than or equal to about 5 μm, less than or equal to about 3 μm, less than or equal to about 2 μm, less than or equal to about 1 μm, less than or equal to about 0.2 μm, and all ranges and subranges therebetween. The minimum thickness of the silver-containing region may be about 10 nm. In some embodiments, the thickness of the silver-containing region is in the range from about 5 μm to about 8 μm or from about 2 μm to about 5 μm and all ranges and subranges therebetween.

In contrast, if the silver-containing region is formed at the same time as the compressive stress layer, and both are formed via chemical ion exchange, then the thickness of the silver-containing region generally may be up to about 150 μm. In some embodiments, the thickness of the silver-containing region may be in the range from about 20 μm to about 100 μm, from about 20 μm to about 150 μm, or from about 20 μm to about 300 μm, and all ranges and subranges therebetween.

In specific embodiments that might be particularly advantageous for applications such as touch accessed or operated electronic devices, an antimicrobial article is formed from a chemically strengthened (ion exchanged) alkali aluminosilicate flat glass sheet. The thickness of the glass sheet is less than or equal to about 1 mm, the DOC of the ion exchanged compressive stress layer on each major surface of the glass sheet may be about 40 μm to about 200 μm, and the CS across the depth of the compressive stress layer on each major surface may be about 400 MPa to about 1.1 GPa. The thickness of the silver-containing region, which is formed by a second ion exchange step that occurs after compressive stress layer is formed, may be about 500 nm to about 10 μm. An Ag₂O concentration of about 0 mol % to about 2 mol % can be attained in the outermost (i.e., closest to the glass substrate surface) 5 nm of the silver-containing region. This antimicrobial article can have an initial optical transmittance of at least about 90% across the visible spectrum and a haze of less than 1%.

Embodiments of the antimicrobial glass articles described herein exhibit improved mechanical performance. In one or more embodiments, the articles exhibit an average flexural strength, as measured by ring-on-ring load to failure testing, as described herein, of about 250 kgf or greater. The average flexural strength can be measured by known methods such as ring-on-ring testing performed according to the ASTM C-1499-03 standard test method for Monotonic Equibiaxial Flexural Strength of Advanced Ceramics at Ambient Temperatures. As used herein, the term “average flexural strength” is intended to refer to the flexural strength of the article, as tested through methods such as ring-on-ring testing. The term “average” when used in connection with average flexural strength or any other property is based on the mathematical average of measurements of such property on at least 5 samples, at least 10 samples or at least 15 samples or at least 20 samples. Average flexural strength may refer to the scale parameter of two parameter Weibull statistics of failure load under ring-on-ring testing. This scale parameter is also called the Weibull characteristic strength, at which the failure probability of a brittle material is 63.2%.

Compressive stress and DOC can be measured using those means known in the art. Compressive stress (including surface CS) can be measured by surface stress meter (FSM) using commercially available instruments such as the FSM-6000, manufactured by Orihara Industrial Co., Ltd. (Japan). Surface stress measurements rely upon the accurate measurement of the stress optical coefficient (SOC), which is related to the birefringence of the glass. SOC in turn is measured according to Procedure C (Glass Disc Method) described in ASTM standard C770-16, entitled “Standard Test Method for Measurement of Glass Stress-Optical Coefficient,” the contents of which are incorporated herein by reference in their entirety. As used herein, DOC means the depth at which the stress in the article described herein changes from compressive to tensile. DOC may be measured by FSM or a scattered light polariscope (SCALP) depending on the ion exchange treatment. In some embodiments where the stress in the glass article is generated by exchanging potassium ions into the glass article, FSM is used to measure DOC. Where the stress is generated by exchanging sodium ions into the glass article, SCALP is used to measure DOC. Where the stress in the glass article is generated by exchanging both potassium and sodium ions into the glass, the DOC is measured by SCALP, since it is believed the exchange depth of sodium indicates the DOC and the exchange depth of potassium ions indicates a change in the magnitude of the compressive stress (but not the change in stress from compressive to tensile); the exchange depth of potassium ions in such glass articles can be measured by FSM.

In certain implementations, the article can include an additional layer disposed on the surface of the substrate. The optional additional layer(s) can be used to provide additional features to the article (e.g., reflection resistance or anti-reflection properties, glare resistance or anti-glare properties, fingerprint resistance or anti-fingerprint properties, smudge resistance or anti-smudge properties, color, opacity, environmental barrier protection, electronic functionality, and/or the like). Materials that can be used to form the optional additional layer(s) generally are known to those skilled in the art to which this disclosure pertains.

In certain cases, one of the major surfaces of the article can have an anti-reflection coating and/or an anti-fingerprint coating disposed thereon. After deposition of the anti-reflection coating and/or the anti-fingerprint coating (which can involve temperatures of greater than 200° C., relative humidities of greater than 80%, and exposure to plasma cleaning steps before and/or after deposition), the antimicrobial article can have an optical transmittance of at least about 90% across the visible spectrum and a haze of less than 1%. In addition, the change in the L*, a*, and b* coordinates of the article after deposition of the anti-reflection coating and/or the anti-fingerprint coating (relative to the uncoated article) can be less than about ±0.15, ±0.08, and ±0.08, respectively. Such an antimicrobial article can be used in the fabrication of a touch screen display for an electronic device, offering desirable strength, optical properties, antimicrobial behavior, and reduced discoloration. In addition, such an antimicrobial article can exhibit at least a 5 log reduction in the concentration any bacteria to which it is exposed under the testing conditions of JIS Z 2801.

When an optional additional layer is used, the thickness of such a layer will depend on the function it serves. For example if a glare- and/or reflection-resistant layer is implemented, the thickness of such a layer should be less than or equal to about 200 nm. Coatings that have a thickness greater than this could scatter light in such a manner that defeats the glare and/or reflection resistance properties. Similarly, if a fingerprint- and/or smudge-resistant layer is implemented, the thickness of such a layer should be less than or equal to about 100 nm.

Depending on the materials chosen, the additional layer can be formed using a variety of techniques. For example, the optional additional layer(s) can be fabricated independently using any of the variants of chemical vapor deposition (CVD) (e.g., plasma-enhanced CVD, aerosol-assisted CVD, metal organic CVD, and the like), any of the variants of physical vapor deposition (PVD) (e.g., ion-assisted PVD, pulsed laser deposition, cathodic arc deposition, sputtering, and the like), spray coating, spin-coating, dip-coating, inkjetting, sol-gel processing, or the like. Such processes are known to those skilled in the art to which this disclosure pertains. The selection of materials used in the substrates and optional additional layers can be made based on the particular application desired for the final article.

### EXAMPLES

Various embodiments will be further clarified by the following examples.

### Example 1

Fabricating an Antimicrobial Glass Article

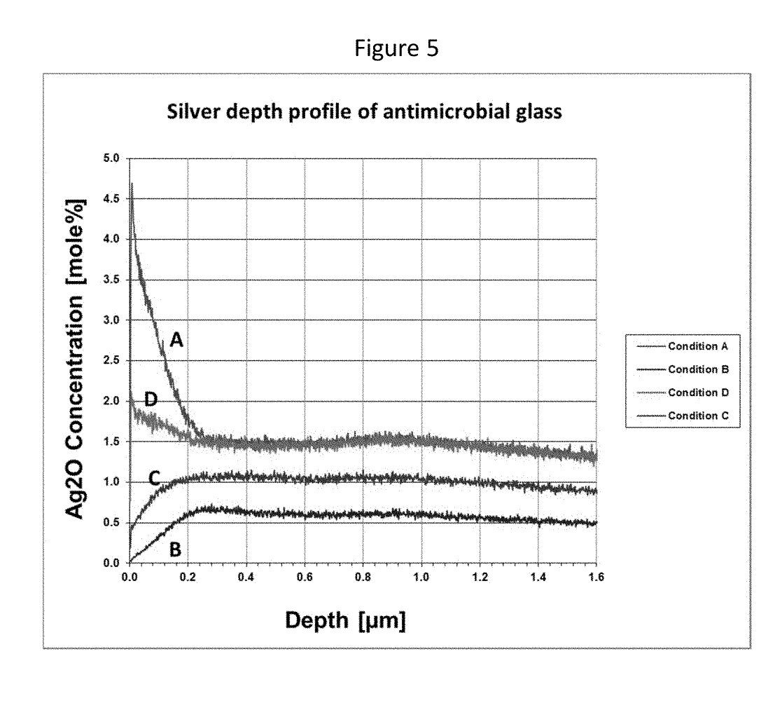

Samples having a size of 50 mm width by 50 mm length by 0.7 mm thickness of a glass (having a composition of approximately 67.37 mol % SiO₂, 3.67 mol % B₂O₃, 12.73 mol % Al₂O₃, 13.77 mol % Na₂O, 0.01 mol % K₂O, 2.39 mol % MgO, 0.01 mol % Fe₂O₃, 0.01 mol % ZrO₂ and 0.09 mol % SnO₂) were ion exchanged in a first molten bath comprising 100% KNO₃ molten salt at 420° C. for 5 hr. Then, the samples were divided into Groups A-D and were ion exchanged in a second molten salt bath having the composition and conditions listed in Table 1. After the second ion exchange the samples were cleaned with deionized water and a detergent wash. The silver concentration based on silver oxide was measured as a function of depth using Secondary-Ion Mass Spectrometry (SIMS) and the results for samples in each of Groups A-D are shown in FIG. 5.

TABLE 1
Antimicrobial glasses made from different ion exchange processes (molten salt
composition and concentration).

| | | | | | | | | Results | | |
|---|---|---|---|---|---|---|---|---|---|---|
| | | | | | | | | Ag₂O | | |
| | | IOX Condition | | | | | | Concentration at | Ag from | Surface |
| Group | | AgNO₃ | KCl | K₂SO₄ | KNO₃ | Temp. | Time | 40 nm (0.04 μm) | leaching | Defect |
| # | Description | (wt %) | (wt %) | (wt %) | (wt %) | (° C.) | (h) | depth (mol %) | test (ppb) | (stain) |
| A | Control | 0.50 | n/a | n/a | 99.50 | 390 | 1 | 2.96 | 370 | Yes |
| B | Add Chloride | 0.50 | 0.22 | n/a | 99.28 | 390 | 1 | 0.26 | 36 | No |
| C | Add less | 0.50 | 0.07 | n/a | 99.43 | 430 | 0.5 | 0.73 | 88 | No |
| | Chloride | | | | | | | | | |
| D | Add Sulfate | 0.50 | n/a | 0.26 | 99.24 | 390 | 1 | 1.82 | 110 | Yes |

As can be seen in FIG. 5, Groups B and C which included chloride anions in the second molten salt bath, resulted in the Ag₂O concentration generally increasing over the first 200 nm (0.2 μm) such that the Ag₂O concentration at 200 nm was greater than the Ag concentration at 40 nm. More added chloride (Group B) further caused lower Ag₂O concentration at 40 nm and less Ag leaching from the surface. Group A, which just had nitrate anions in the second molten bath had the highest Ag₂O concentration at about 40 nm and the Ag₂O concentration generally decreased over the first 200 nm (0.2 μm) such that Ag₂O concentration at 40 nm was greater than the Ag₂O concentration at 200 nm. Group D, which included sulfate ions, resulted in the Ag₂O concentration generally decreasing over the first 200 nm (0.2 μm) such that the Ag₂O concentration at 40 nm was greater than the Ag₂O concentration at 200 nm. However, in Group D, the surface Ag₂O concentration (within 5 nm) and Ag₂O concentration at 40 nm were much lower than those of Group A, and the difference of the Ag₂O concentration at 200 nm and Ag₂O concentration at 40 nm of Group D was also smaller than that of Group A.

Samples from each of Groups A-D were treated at 400° C. for 1 hour in a hydrogen environment and were subsequently visually inspected to determine if the surface contained a stain defect. Silver stain defects showed up much easier after the above treatment. As shown in Table 1 above, stains were observed for Groups A and D, but not B and C. Thus, including chloride ions in the second molten bath prevented the formation of stains under the above conditions. Although stains were still observed for Group B after hydrogen treatment, they were less pronounced than Group A.

Samples from each of Groups A-D were subjected to the following leaching test to evaluate the antimicrobial performance of the samples. A 1.5 inch×1.5 inch area of each sample was covered by 700 μL of 10 mM NaNO₃ solution, and heated at 60° C. for 2 hours. After the treatment, the solution from each sample was collected and the silver ion concentration was measured using Inductively Coupled Plasma Mass Spectrometry (ICP-MS). The results are shown in Table 1 above. The introduction of additional anions into the second molten bath reduced Ag leaching from the samples. Groups B and D had Ag leaching >70 ppb, which suggests probably at least a 2 log reduction in a concentration of at least Staphylococcus aureus, Enterobacter aerogenes, and Pseudomonas aeruginosa bacteria under JIS Z 2801 (2000) testing conditions.

What is claimed is:

1. An article, comprising:
a substrate comprising a compressive stress layer that extends inward from a surface of the substrate to a first depth therein and a silver-containing region that extends inward from the surface of the substrate to a second depth therein, wherein an Ag₂O concentration at a depth of 200 nanometers (nm) is greater than the Ag₂O concentration at a depth of 40 nm.

2. The article of claim 1, wherein the second depth is less than the first depth.

3. The article of claim 1, further comprising an additional layer disposed on the surface of the substrate.

4. The article of claim 3, wherein the additional layer comprises a reflection-resistant coating, a glare-resistant coating, a fingerprint-resistant coating, a smudge-resistant coating, a color-providing composition, an environmental barrier coating, or an electrically conductive coating.

5. The article of claim 1, wherein a maximum compressive stress of the compressive stress layer is in a range from about 200 megapascals (MPa) to about 1.2 gigapascals (GPa) and a depth of the compressive stress layer is less than about 200 micrometers (μm).

6. The article of claim 1, wherein the silver-containing region has a depth of less than or equal to about 150 μm.

7. The article of claim 1, wherein the article exhibits substantially no discoloration, wherein substantially no discoloration occurs as determined by at least one of:
a change in optical transmittance of the article of less than or equal to about 3 percent relative to an optical transmittance after reduction by hydrogen (H₂),
a change in haze of the article of less than or equal to about 5 percent relative to a haze after reduction by H₂, and
a change in CIE 1976 color coordinates L*, a*, and b* of the article of less than or equal to about ±0.2, ±0.1, and ±0.1, respectively, after reduction by H₂.

8. The article of claim 1, wherein after immersing the article having a size of 1.5 inch×1.5 inch in a 700 uL solution of 10 mM NaNO₃ at 60° C. for 2 hours, the article leaches up to about 100 parts per billion (ppb) of silver ions into the solution.

9. The article of claim 1, wherein the article exhibits at least a 2 log reduction in a concentration of at least Staphylococcus aureus, Enterobacter aerogenes, and Pseudomonas aeruginosa bacteria under JIS Z 2801 (2000) testing conditions.

10. The article of claim 1, wherein the substrate comprises at least one of a glass, glass ceramic and ceramic composition.

11. The article of claim 1, wherein the article comprises a portion of a touch-sensitive display screen or cover plate for an electronic device, a non-touch-sensitive component of an electronic device, a surface of a household appliance, a surface of medical equipment, a biological or medical packaging vessel, or a surface of a vehicle component.

12. A consumer electronic product, comprising:
a housing having a front surface, a back surface and side surfaces;
electrical components provided at least partially within the housing, the electrical components including at least a controller, a memory, and a display, the display being provided at or adjacent the front surface of the housing; and
a cover substrate disposed over the display,
wherein at least one of a portion of the housing or the cover substrate comprises the article of claim 1.

13. An article, comprising:
a substrate comprising a compressive stress layer that extends inward from a surface of the substrate to a first depth therein and a silver-containing region that extends inward from the surface of the substrate to a second depth therein, wherein across the surface of the substrate there is a maximum Ag₂O concentration [Ag₂Oₘₐₓ] and a minimum Ag₂O concentration [Ag₂Oₘᵢₙ], wherein [Ag₂Oₘₐₓ]−[Ag₂Oₘᵢₙ] is less than or equal to about 0.5 mol %.

14. The article of claim 13, wherein the second depth is less than the first depth.

15. The article of claim 13, further comprising an additional layer disposed on the surface of the substrate.

16. The article of claim 15, wherein the additional layer comprises a reflection-resistant coating, a glare-resistant coating, a fingerprint-resistant coating, a smudge-resistant coating, a color-providing composition, an environmental barrier coating, or an electrically conductive coating.

17. The article of claim 13, wherein a maximum compressive stress of the compressive stress layer is about 200 MPa to about 1.2 GPa and a depth of the compressive stress layer is less than about 200 μm.

18. The article of claim 13, wherein the silver-containing region has a depth of less than or equal to about 150 μm.

19. The article of claim 13, wherein the article exhibits substantially no discoloration, wherein substantially no discoloration occurs as determined by at least one of:
a change in optical transmittance of the article of less than or equal to about 3 percent relative to an optical transmittance after reduction by hydrogen (H₂),
a change in haze of the article of less than or equal to about 5 percent relative to a haze after reduction by H₂, and
a change in CIE 1976 color coordinates L*, a*, and b* of the article of less than or equal to about ±0.2, ±0.1, and ±0.1, respectively, after reduction by H₂.

20. The article of claim 13, wherein after immersing the article having a size of 1.5 inch×1.5 inch in a 700 uL solution of 10 mM NaNO₃ at 60° C. for 2 hours, the article leaches up to about 100 parts per billion (ppb) of silver ions into the solution.

21. The article of claim 13, wherein the article exhibits at least a 2 log reduction in a concentration of at least Staphylococcus aureus, Enterobacter aerogenes, and Pseudomonas aeruginosa bacteria under JIS Z 2801 (2000) testing conditions.

22. The article of claim 13, wherein the substrate comprises at least one of a glass, glass ceramic and ceramic composition.

23. The article of claim 13, wherein the article comprises a portion of a touch-sensitive display screen or cover plate for an electronic device, a non-touch-sensitive component of an electronic device, a surface of a household appliance, a surface of medical equipment, a biological or medical packaging vessel, or a surface of a vehicle component.

24. The article of claim 13, wherein [Ag₂Oₘₐₓ]−[Ag₂Oₘᵢₙ] is less than or equal to about 0.3 mol %.

25. A consumer electronic product, comprising:
a housing having a front surface, a back surface and side surfaces;
electrical components provided at least partially within the housing, the electrical components including at least a controller, a memory, and a display, the display being provided at or adjacent the front surface of the housing; and
a cover substrate disposed over the display,
wherein at least one of a portion of the housing or the cover substrate comprises the article of claim 13.

26. A method of making an article, the method comprising:
contacting at least a surface of a substrate with a silver-containing medium comprising at least one kind of anion to form a silver-containing region in the substrate that extends inward from the surface of the substrate to a first depth, wherein an Ag₂O concentration at a depth of 200 nanometers (nm) is greater than the Ag₂O concentration at a depth of 40 nm.

27. The method of claim 26, wherein the at least one kind of anion is selected from a group consisting of Cl⁻, SO₄²⁻, F⁻, I⁻, Br⁻, CO₃²⁻, PO₄³, and a mixture thereof.

28. The method of claim 26, further comprising forming a compressive stress layer that extends inward from the surface of the substrate to a second depth.

29. The method of claim 28, wherein forming the silver-containing region and forming the compressive stress layer occur simultaneously.

30. The method of claim 26, wherein the silver-containing medium is a molten salt bath comprising silver cations.

31. The method of claim 30, wherein the molten salt bath further comprises at least one of NaNO₃ and KNO₃.

32. The method of claim 30, wherein the silver cations are present in an amount in a range from about 0.1 wt % to about 10 wt %, based on the total weight of the molten salt bath.

33. The method of claim 30, wherein the at least one kind of anion is present in an amount in a range from about 0.01 wt % to about 10 wt %, based on the total weight of the molten salt bath.

34. The method of claim 26, wherein the silver-containing medium is heated to a temperature in a range from about 350° C. to about 450° C.

35. The method of claim 26, wherein contacting the substrate with the silver-containing medium takes place for a duration in a range from about 10 minutes to about 10 hours.

36. The method of claim 26, further comprising forming an additional layer on at least a portion of the surface of the substrate, wherein the additional layer is selected from the group consisting of a reflection-resistant coating, a glare-resistant coating, a fingerprint-resistant coating, a smudge-resistant coating, a color-providing composition, an environmental barrier coating, and an electrically conductive coating.

37. The method of claim 26, wherein the Ag₂O concentration at a depth of 40 nm inward from a surface of the article is up to about 2 mol %.

38. The method of claim 26, wherein across the surface of the article there is a maximum Ag₂O concentration [Ag₂Oₘₐₓ] and a minimum Ag₂O concentration [Ag₂Oₘᵢₙ], wherein [Ag₂Oₘₐₓ]−[Ag₂Oₘᵢₙ] is less than or equal to about 0.5 mol %.

39. The method of claim 38, wherein [Ag₂Oₘₐₓ]−[Ag₂Oₘᵢₙ] is less than or equal to about 0.3 mol %.

40. The method of claim 26, wherein the article exhibits substantially no discoloration, wherein substantially no discoloration occurs as determined by at least one of:
a change in optical transmittance of the article of less than or equal to about 3 percent relative to an optical transmittance after reduction by hydrogen (H₂),
a change in haze of the article of less than or equal to about 5 percent relative to a haze after reduction by H₂, and
a change in CIE 1976 color coordinates L*, a*, and b* of the article of less than or equal to about ±0.2, ±0.1, and ±0.1, respectively, after reduction by H₂.
